(19) United States
(12) Patent Application Publication
(10) Pub. No.: US 2021/0350390 A1
(43) Pub. Date: Nov. 11, 2021

(54) STAKEHOLDER LIFECYCLE MANAGEMENT METHODOLOGY FOR B2B SALES PROSPECTING

(71) Applicant: Strongware Technologies LLC dba Tohoom, Birmingham, MI (US)

(72) Inventor: Ralph A. Strong, II, Birmingham, MI (US)

(21) Appl. No.: 16/868,150

(22) Filed: May 6, 2020

(51) Int. Cl. G06Q 30/02; G06Q 30/00

(52) U.S. Cl. CPC G06Q 30/0201; G06Q 30/01

(57) ABSTRACT

A method and computer system for managing sales prospects, spanning the entire lifecycle of sales prospecting—from the identification of a desired customer account, to the development of a relationship with the proper person(s), to a selling opportunity. Organizational roles and individual contacts are identified for each sales account, and data is tracked as the contacts are found and developed. The disclosed method includes target, find, connect and collaborate phases. The target phase includes identifying the target role at the account. In the find phase, the name of the individual occupying the target role is determined. A relationship with the individual is established in the connect phase, and the relationship is developed in the collaborate phase. Tracking tools are provided to ensure that milestones are met by sales representatives. A two-way interface to traditional CRM software is provided, where the CRM system handles selling opportunities resulting from the sales prospecting.

### BACKGROUND

### Field

The present disclosure relates generally to a method and computer system for managing sales prospects. More particularly, it relates to a pre-opportunity sales prospecting method and system which includes phases of target, find, connect and collaborate. Organizational roles and individual contacts are identified for each sales account, and data is tracked as the contacts are found and developed. A two-way interface to traditional Customer Relationship Management (CRM) software is provided, where the CRM system handles specific selling opportunities resulting from the sales prospecting.

### Discussion of the Related Art

Customer Relationship Management (CRM) systems are known which manage a company's interaction with current and potential customers. CRM systems use data analysis about customers' history with a company to improve business relationships with customers, specifically focusing on customer retention and ultimately driving sales growth.

CRM systems have demonstrated strong capability for tracking data about existing customers, and managing specific sales opportunities to those customers. However, most sales organizations, in addition to selling to existing customers, expend a lot of effort prospecting for new customers and accounts. Existing CRM systems and other systems do not offer the capability needed for effective and efficient tracking of sales prospects from the beginning of the prospecting lifecycle to the end.

### SUMMARY

The present disclosure describes a method and computer system for managing sales prospects. The method and system span the entire lifecycle of sales prospecting—from the identification of a desired customer or account, to the development of a relationship with the proper person(s), ultimately leading to a selling opportunity. Organizational roles and individual contacts are identified for each sales account, and data is tracked as the contacts are found and developed. The sales prospecting method and system include phases of target, find, connect and collaborate. The target phase includes identifying the proper organization role to target at the account. In the find phase, the name of the individual occupying the target role is determined. A relationship with the individual is established in the connect phase, and the relationship is developed and nurtured in the collaborate phase. Tracking tools are provided to ensure that prospect development milestones are met by sales representatives. A two-way interface to traditional Customer Relationship Management (CRM) software is provided, where the CRM system handles specific selling opportunities resulting from the sales prospecting.

Additional features of the present disclosure will become apparent from the following description and appended claims, taken in conjunction with the accompanying drawings.

### BRIEF DESCRIPTION OF THE DRAWINGS

FIG. 1 is a block diagram illustration of a system architecture for the Tohoom stakeholder lifecycle management system;

FIG. 2 is an illustration of a Tohoom user interface page for a Hoom, or a persona at an account with the budget and authority to buy something, according to an embodiment of the present disclosure;

FIG. 3 is an illustration of a portion of the Tohoom user interface page for the Hoom of FIG. 2, showing details of Target, Find and Connect phases, according to an embodiment of the present disclosure;

FIG. 4 is an illustration of a portion of a Tohoom user interface page showing a list of all Hooms for a sales representative, according to an embodiment of the present disclosure;

FIG. 5 is an illustration of a portion of a Tohoom user interface page showing a list of Influencers for a particular Hoom, according to an embodiment of the present disclosure;

FIG. 6 is an illustration of a portion of a Tohoom user interface page showing a list of Collaborations for a particular Hoom, according to an embodiment of the present disclosure;

FIG. 7 is an illustration of a Tohoom user interface page for a list of HUBs, or Hoom Update Briefs, according to an embodiment of the present disclosure;

FIG. 8 is an illustration of a Tohoom user interface page for details of a specific HUB from the list of FIG. 7, according to an embodiment of the present disclosure;

FIG. 9 is an illustration of a Tohoom user interface page for a Dashboard, or a collection of data graphs and charts for a particular user, according to an embodiment of the present disclosure;

FIG. 10 is an illustration of a Tohoom user interface page for details of a Hoom and showing a First Conversations summary, according to an embodiment of the present disclosure;

FIG. 11 is an illustration of a Tohoom user interface page for First Conversations details, according to an embodiment of the present disclosure;

FIG. 12 is an illustration of a Tohoom user interface page for an Influencer Map, according to an embodiment of the present disclosure; and

FIG. 13 is a flowchart diagram of a method for sales prospecting stakeholder lifecycle management using the Tohoom system, according to an embodiment of the present disclosure.

### DETAILED DESCRIPTION OF THE EMBODIMENTS

The following discussion of the embodiments of the disclosure directed to a method and computer system for managing sales prospects is merely exemplary in nature, and is in no way intended to limit the invention or its applications or uses.

Customer Relationship Management (CRM) systems are widely used by the sales departments of product manufacturers and service providers. CRM systems provide capabilities for managing information about customers and sales—such as what sales have been made to a customer in the past (what was sold, and the price), and opportunities for future sales.

However, for sales representatives, a great deal of effort goes into prospecting for new accounts and developing the prospects into sales. Until now, sales representatives have not had a good tool for managing their sales prospecting activity, and have been forced to use spreadsheets and the like. These primitive tools lack proper database relationships and therefore require redundant data entry and/or complicated macros and pivot tables. Such tools are also not suitable for multiple users, or role-based data entry and viewing, and lack other needed features.

The present disclosure describes a method and computer system for managing sales prospects. The disclosed method and system span the entire lifecycle of sales prospecting—from the identification of a desired customer or account, to the development of a relationship with the proper person(s) at the account, ultimately leading to a selling opportunity. The method has been embodied in a database-driven computer system called Tohoom. Tohoom is a stakeholder lifecycle management system for sales prospecting.

Throughout the ensuing discussion of Tohoom, the following terms and definitions will be used:
vendor—the company which is selling a product or service
sales organization—the selling department of the vendor
FLSM—first line sales manager—a manager in the sales organization to whom multiple sales representatives report
sales representative or “rep”—person responsible for sales prospecting and developing relationships
customer or client—the company which is buying the product or service
account—the business unit within the company which is buying (such as a specific division of a large manufacturing company); account may be same as customer
persona—an organization role (such as Engineering Director, or Chief Information Officer) within the account
“Hoom”—the “economic buyer”, or the persona at the account who has the budget and authority to buy something; identifying and developing a relationship with the Hoom is the focus of the disclosed method and Tohoom software system
influencer—personas in various roles at the account who may influence a purchase decision (such as a user buyer, a technical buyer, an attorney, etc.)
contact—an individual person (e.g., “Michelle Smith”) associated with any of the personas—i.e., the Hoom or an influencer
opportunity—a specific selling opportunity which results from the sales prospecting methodology of the present disclosure; the selling opportunity is typically managed in the CRM system

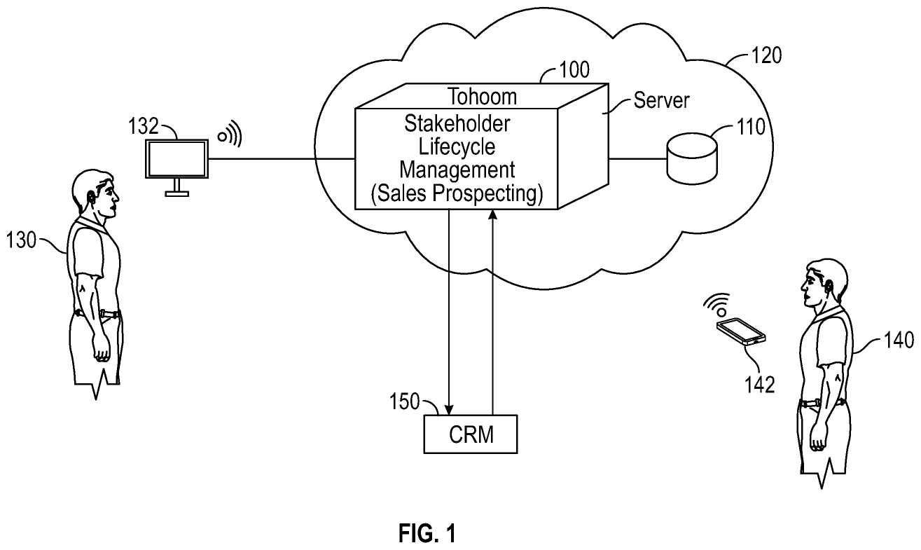

FIG. 1 is a block diagram illustration of a system architecture for the Tohoom stakeholder lifecycle management system. Tohoom may be used as a web application and/or a mobile “app”. That is, the Tohoom users in the sales organization may access the application using a web browser on a desktop or laptop computer. The users may also access the application from a mobile device running an app.

A server 100 runs the Tohoom sales prospecting/stakeholder lifecycle management system. The Tohoom system on the server 100 has a back-end database 110. The server 100 is typically located “in the cloud” 120—i.e., managed by a computing services provider and available on the Internet.

Regardless of the hosting arrangement, the Tohoom system is accessed by users 130 and 140, representative of all users. The user 130 is a typical user in the vendor sales department using a computer 132. The computer 132 is typically a personal computer running web browser software, where the Tohoom system is served as web pages from the server 100 to the computer 132 in a known manner. The user 130 is either physically located at a company office with a hard-wire connection to the server 100, or has access to the server 100 through a VPN connection or the like. Any individual network connection between the computer 132 and the server 100 (or the cloud 120) may be hard-wired or wireless.

The user 140 is a mobile user having a mobile device 142. The mobile device 142 wirelessly communicates with the cloud 120 and/or the server 100 in a known manner. The mobile device 142 runs an application (“app”) specifically designed to interact with the server portion of the Tohoom system, also in a manner known to those skilled in the art.

In a preferred embodiment, the Tohoom system on the server 110 has a two-way interface with a customer relationship management (CRM) system 150. Sales prospects reaching a certain level of maturity in the Tohoom system may be provided to the CRM system 150 to be worked as sales opportunities, and certain customer data (such as actual sales) may be provided to the Tohoom system.

Users have roles in the Tohoom system, and roles in turn have data access privileges. That is, the data that an individual user can view and/or edit is based on that user's role in the system. For example, a sales rep has authority to enter and update certain fields in the system for accounts that he is responsible for. A first line sales manager who has several sales reps reporting to her has the authority to view all of her sales reps' data, and to change or update some of it. A sales director has access to view all data for all sales managers and reps. This sort of role-based security ensures data integrity in the Tohoom system.

A basic underlying goal of Tohoom is to find the people that a sales rep should be selling to, and to develop those relationships over time. In order to find the right people in an orderly and organized fashion, data relationships are established for each sales account. These data relationships define particular organizational roles at the account (such as purchasing manager, engineering director, etc.), then identify which roles are key to making a sale, and which are supporting roles. The individual persons filling each role are then determined, and those relationships are developed over time. Until now, this sort of pre-sales prospecting has not been embodied in a data-driven stakeholder lifecycle management system.

The following discussion of the Tohoom system and methodology refers to a series of illustrations of actual user interface “screen shots”. From these figures and the corresponding discussion, the features and underlying data relationships of the Tohoom system are made apparent.

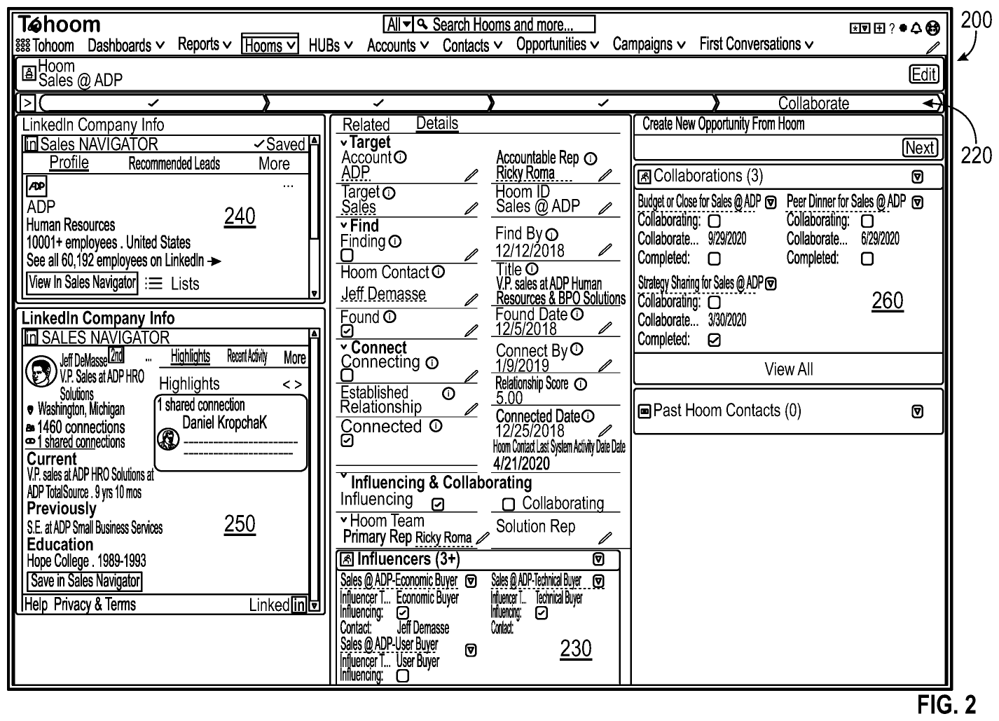

FIG. 2 is an illustration of a Tohoom user interface page 200 for a Hoom, or a persona at an account with the budget and authority to buy something, according to an embodiment of the present disclosure. FIG. 2 and the figures that follow are illustrations of Tohoom user interface screens as they would typically appear in a web browser application on a personal computer. User interface appearance may be different in a mobile app. Furthermore, user interface appearance and design may be changed over time, while the underlying features, functions and data relationships of the system remain essentially the same. The user interface screens and appearance of the figures, shown and discussed herein, are merely exemplary.

The Hoom page 200, like all pages in the Tohoom system, includes a tab bar 210 containing a standard set of drop-list menu tabs—such as Dashboards, Reports, Hooms, . . . , Accounts, Contacts, etc. In the case of the page 200, the user has clicked on Hooms to get a drop-list of the user's Hooms, and selected one. The title of the current page is identified at 212, where it can be seen that the current page is a Hoom page for the Hoom Sales @ ADP.

The Hoom page 200 includes a phase status bar 220 showing the phase status of the particular Hoom being displayed. The sales prospecting methodology embodied in Tohoom includes four phases; Target, Find, Connect and Collaborate. The four phases are shown, in this order, in the phase status bar 220. The status of each phase is shown via color coding, with green indicating that a phase is complete.

The details of the particular Hoom are displayed and updated in a details widget 230 at the center of the Hoom page 200. The widget 230 will be discussed in detail in the next figure. Also included on the Hoom page 200, and discussed later, are a company information widget 240 for the account associated with the Hoom, a Hoom contact information widget 250 for the particular Hoom, and a collaborations widget 260 associated with the Hoom. A widget is essentially a window pane within a screen containing a certain pre-formatted set of information. In some instances, widgets may be moved around on a screen to suit user preference.

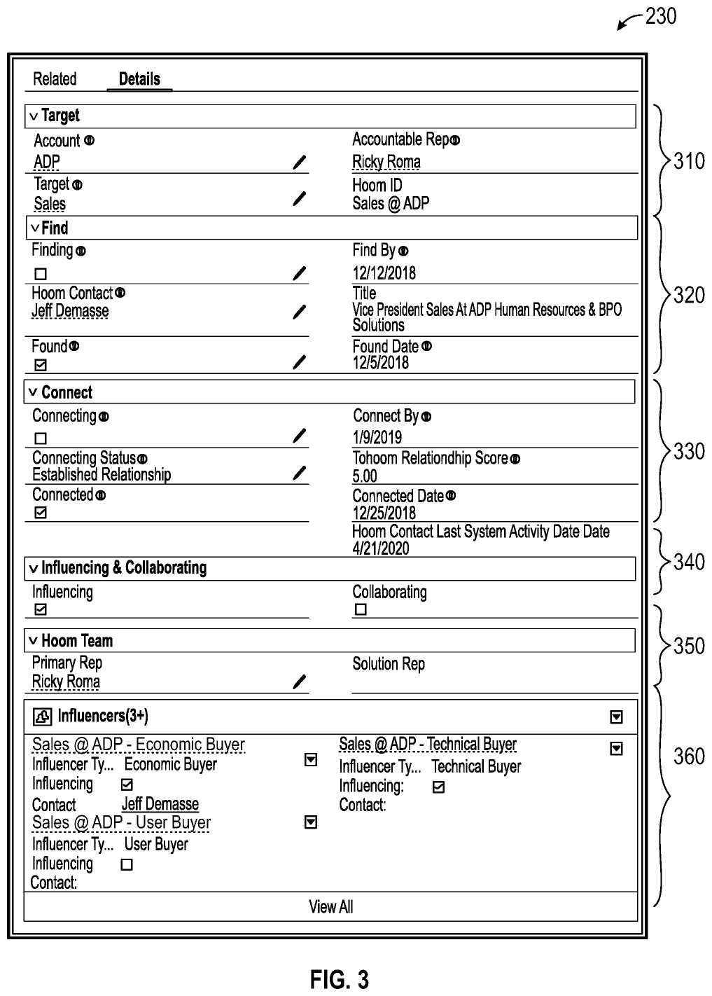

FIG. 3 is an illustration of a portion of the Tohoom user interface page for the Hoom of FIG. 2, showing details of Target, Find and Connect phases, according to an embodiment of the present disclosure. FIG. 3 is a magnified view of the Hoom details widget 230 shown on the Hoom page 200 in FIG. 2. The Hoom details widget 230 serves as a template for progression through the Target, Find and Connect phases of Hoom relationship building.

The first step is the Target phase which is done at implementation. The sales leadership determines the Targets or personas the sales team sells to. Additional Targets can be added at a later date if sales leadership decides to expand their sales target group. The accounts are selected by the sales rep. Once these two tasks are completed, the system administrator loads this data into Tohoom. The data loading includes Target (personas selling to), Accounts (sales reps account list), and Hooms (intersection of Target at Account). When a sales rep is assigned a new account, he begins in a Target section 310. The name of the sales rep is shown at the top right of the Target section 310. The name of the account, which is the company or division being targeted for sales, is also included in the Account data field at the top left of the Target section 310. The account name is pulled from the CRM system. The company information can be populated with data about the account from a business networking system such as LinkedIn widget 240.

The first task for the sales leadership is to determine the target (the organizational role, not the specific person) at the account; this is the persona to whom the sales rep should be selling. When the sales leadership determines the target organizational role, this data is entered in the Target field of the Target section 310, at implementation by the system administrator. Based on the Account data field and the Target data field, a Hoom ID is created. In this case, where the Account is ADP and the Target is Sales, the Hoom ID is Sales @ ADP, which corresponds with the title 212 shown on the Hoom page 200 in FIG. 2. When the Target is identified and the Hoom ID is created, the Target section 310 is completed, and the target phase of the process is completed. At this point, the Target portion of the phase status bar 220 (FIG. 2) will turn green for this particular Hoom. This section is populated at implementation and all fields are locked/unaccessable to users except the Accountable Rep field. The Accountable Rep field can be changed if the sales rep assigned to the account changes (sales rep leaves company or accounts are reassigned to other reps).

After the Target phase is completed (the Hoom is determined), the next phase is Find. The goal of the Find phase is to identify the contact (the specific individual person) associated with the Hoom ID. It is important to note that in the Tohoom system, the specific person (Hoom Contact) is established as a separate data field from the Hoom. This not only helps the sales rep follow an orderly process for sales prospecting, but also allows Tohoom to properly manage current and historical Hoom Contact data. For example, if a Hoom contact retires from the account company, the Finding phase will have to be re-entered to determine a new Hoom Contact. However, the Target phase will remain green, as the Hoom ID (the organizational role at the account) will remain the same. This feature—managing the specific person (Hoom Contact) separate from the organizational role (Hoom ID), with the two data fields having a hierarchical relationship—is important and is unique to the sales prospecting methodology of Tohoom.

Data for the Find phase is entered in a Find section 320. A Finding checkbox is checked to indicate that the Find phase has commenced. The sales rep and his first line sales manager may collaboratively decide on a Find By date which is then entered at the top right of the Find section 320. Through meetings, phone calls, emails, or whatever other form of investigation is necessary, the sales rep establishes the identity of the Hoom Contact. At this point, the Hoom Contact field and the corresponding Title of the Hoom Contact (job title of this person at the account) are entered in the Find section 320. In a preferred mode of operation, the Hoom Contact field is populated by selecting a person from a list of people at the account which is known from the CRM system (via the interface shown in FIG. 1). Likewise, upon selecting the Hoom Contact from the CRM data, the Title is also populated.

If the name of the Hoom Contact is known from the CRM system, the Hoom contact information can be populated with more detailed data about the contact from the CRM system such as Hoom Contact Last System Activity Date. The data in the Hoom contact information widget 250 is pulled directly from a business networking system such as LinkedIn, as shown in FIG. 2.

A Found checkbox may then be checked to indicate that the Hoom Contact has been found. Clicking the Found checkbox is a feature which may be reserved for the sales manager when she is satisfied that the Hoom Contact satisfies the target criteria. In other words, the sales rep cannot click the Found checkbox himself; this can only be done by his manager. When the Found checkbox is clicked by the manager, the Finding checkbox is unchecked, the Found Date field is automatically populated, and the Find portion of the phase status bar 220 (FIG. 2) will turn green for this particular Hoom. This completes the activity in the Find phase, unless and until the Hoom contact retires, leaves or changes job within the account company; if that happens, then the Hoom Contact is saved as a Past Hoom Contact, and the Find phase is commenced anew.

After the Find phase is completed (the Hoom Contact is determined), the next phase is Connect. The goal of the Connect phase is to connect with the Hoom Contacts and establish a relationship over time. Various connecting outcomes can be captured during the Connect phase, with the goal being fully connected in an established relationship.

Data for the Connect phase is entered in a Connect section 330. A Connecting checkbox is checked to indicate that the Connect phase has commenced. The sales rep and his first line sales manager may collaboratively decide on a Connect By date which is then entered at the top right of the Connect section 330. Through meetings, phone calls, emails, or whatever other form of interaction is appropriate, the sales rep works to establish a connection with the Hoom Contact.

The Connecting Status field is used to keep track of the status/outcome of the connecting activity. The Connecting Status field is created in the Tohoom system as a drop list with the following options: Not Started; In Progress; Accepted Next Step; Defer to Future; Using Competitor; Not Interested; No Response; Stale Relationship; and Established Relationship.

The Tohoom Relationship Score field is automatically updated as the Connecting Status changes. This Score helps each sales rep evaluate their Connection success across all of their accounts and different Target types over time. Established Relationship is the highest level of Connecting Status, and results in a Relationship Score of 5.0. Each selectable value of Connecting Status has an associated Relationship Score ranging from 0.0 to 5.0. The Connected checkbox will automatically be checked, and the Connected Date field is automatically populated, based on the Connecting Status selection. In one embodiment, the Connected checkbox is checked when the Connecting Status is “Accepted Next Step”.

When the Connected checkbox is checked, the Connect portion of the phase status bar 220 (FIG. 2) will turn green for this particular Hoom. This completes the activity in the Connect phase for the time being, unless and until the Hoom contact retires, leaves or changes job within the account company; if that happen, then the Hoom Contact is saved as a Past Hoom Contact, and the Find phase is commenced anew.

The Connect phase may also be re-entered for a particular Hoom if the relationship becomes stale. The Connecting Status field for a Hoom is automatically changed to Stale Relationship in the Tohoom system if no activity has occurred as indicated by the last Connected Date being over 365 days. This period of time (for example, six months, or one year) is configurable as a parameter to be defined by the sales organization of the vendor.

The Hoom details widget 230 of FIG. 3 also includes checkboxes for Influencing and Collaborating, indicated at section 340. The Influencing and Collaborating checkboxes are checked when Influencers have been identified for the Hoom and Collaborating activities have been entered for the Hoom, respectively. Both Influencing and Collaborating are discussed further below.

A Hoom Team section 350 allows for optional designation of Hoom Team members in addition to the sales rep who is the primary team member for the particular Hoom. Other team members may include departments of the vendor company responsible for providing a solution—such as engineering or creative, for example.

Influencers are people at the account who may influence a purchase decision. Influencers are listed in a section 360 of the Hoom details widget 230, and are shown in a later figure and discussed below.

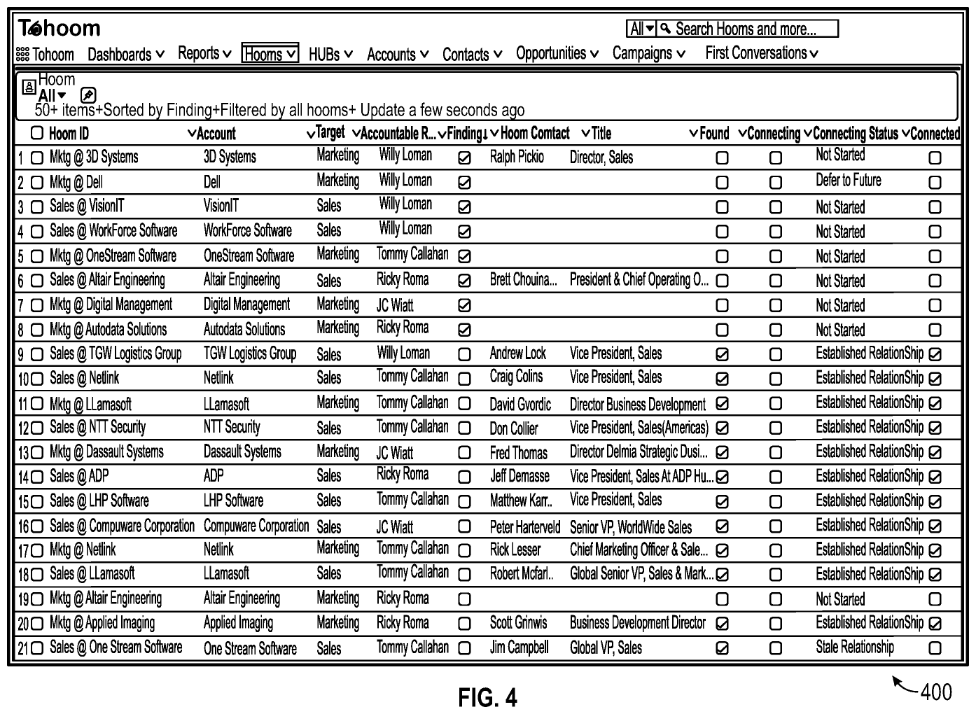

FIG. 4 is an illustration of a portion of a Tohoom user interface page showing a list 400 of all Hooms for a sales representative, according to an embodiment of the present disclosure. The Hooms list 400 of FIG. 4 is accessed by clicking on the Hooms menu tab shown on FIG. 2. Recall that FIG. 2 itself was a display page for one individual Hoom. The Hooms list 400 provides the ability for a sales rep or a first line sales manager to see a listing of Hooms according to defined filtering and sorting criteria, with status information for each Hoom.

The first three columns of the Hooms list 400 are the Hoom ID and the associated Account and Target, as discussed above in relation to FIG. 3. The next column is the Accountable Rep, or the sales rep who “owns” the Hoom. The next four columns in the Hooms list 400 include the Finding checkbox, the Hoom Contact field and associated Title, and the Found checkbox, which operate as discussed above. That is, if the Hoom Contact field is populated, then the Found checkbox will be checked and the Finding checkbox will be unchecked. The last three columns in the Hooms list 400 include the Connecting checkbox, the Connecting Status field and the Connected checkbox, which operate as discussed above. That is, if the Connecting Status field is set to Established Relationship, then the Connected checkbox will be checked and the Connecting checkbox will be unchecked.

If it is desired to make changes to any of the data shown on the Hooms list 400, one of the Hoom IDs can be clicked on, which displays the corresponding Hoom page (as shown in FIGS. 2 and 3). Data can be entered and revised on the Hoom page as discussed earlier. Filtering and sorting options can be applied to the Hooms list 400 in the manner known in the art. For example, the Hooms list 400 could be filtered to only show Hooms for one account, or for one particular sales rep (several accounts). If Hooms for a sales rep having several accounts are shown in the Hooms list 400, the items can be sorted by account if desired.

In the example shown in the Hooms list 400 of FIG. 4, it can be seen that some accounts have more than one Hoom. This illustrates that multiple Hooms per account are possible and often identified, where the different Hooms have different organization roles at the account, but all may be considered an economic buyer.

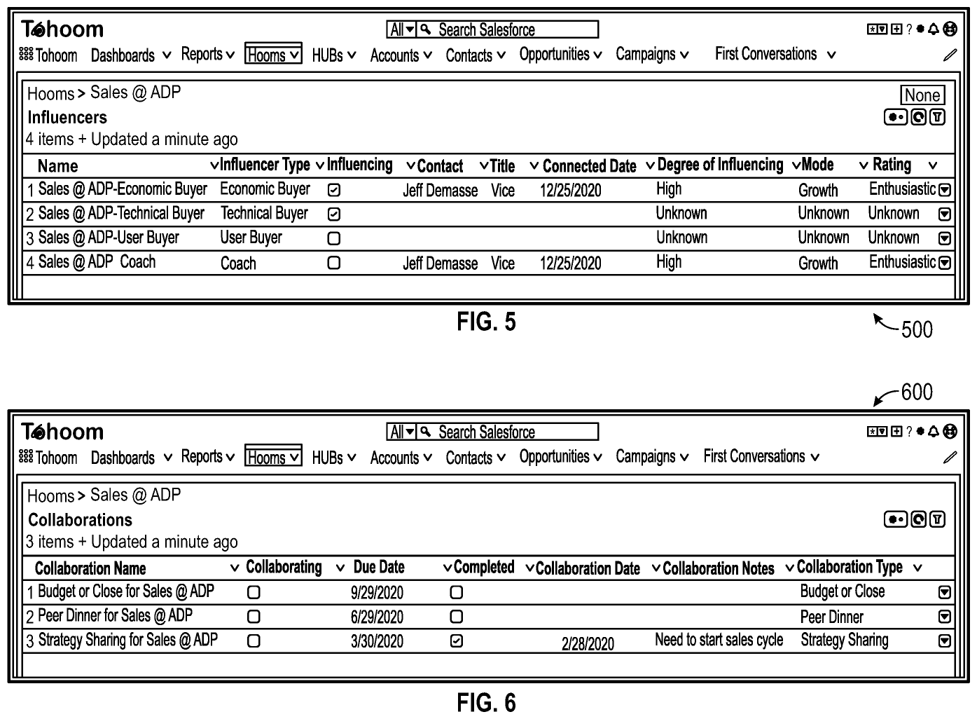

FIG. 5 is an illustration of a portion of a Tohoom user interface page showing a list 500 of Influencers for a particular Hoom, according to an embodiment of the present disclosure. The Influencers list 500 of FIG. 5 is accessed by clicking on the Influencers heading at the top of the section 360 of the Hoom details widget 230 shown on FIG. 3. The Influencers list 500 provides the ability for a sales rep or a first line sales manager to see a listing of Influencers for any individual Hoom. Some of the data in the Influencers list 500 was shown in a different format in the section 360 of the Hoom details widget 230.

The first column of the Influencers list 500 is Name of the Influencer. This is not a person's given name (e.g., Joe Smith), but rather is an organizational role in a manner similar to a Hoom ID. The next column is the Influencer Type—which may have values including Economic Buyer (the Hoom), Technical Buyer, User Buyer and Coach. As discussed earlier, these different types of influencers are all people at the account who can influence a purchase decision. Other types of Influencers could be added in a configuration of Tohoom for a particular vendor if desired. The Influencer Type is incorporated into the Influencer Name as shown. An Influencing checkbox which follows the Influencer Name and Type is used to indicate which Influencers are actively being worked with by the sales rep.

The next three columns in the Influencers list 500 include Contact (Name), (Contact) Title and Connected Date. For each Influencer Name (organization role and type), an individual person must then be identified by the sales rep or other Hoom team member. If an individual can be identified who is included in the CRM system data for the account, then the person can be selected and the Contact (Name) and (Contact) Title fields will be populated for the Influencer. At that point, the Connected Date field is entered by the sales rep which identifies that the rep has connected with this person.

The next column in the Influencers list 500 is the Degree of Influence. The Degree of Influence indicates the “weight” or “power” that the particular Influencer is believed to have in the purchase decision, and may be selected from a drop list including Low, Medium and High. The next column in the Influencers list 500 is the Mode. The Mode indicates the disposition that the Influencer has to doing anything from a business perspective, and may be selected from a drop list including; Growth (expanding business), Troubled (need help with their business), Even Keel (are fine without your product), and Over Confident (can't see need for your product). The last column in the Influencers list 500 is the Rating. The Rating indicates the disposition that the Influencer has toward the product or solution the sales rep is selling, and may be selected from a drop list including Enthusiastic, Interested, Negative and Antagonistic.

When it is desired to make changes to any of the data shown on the Influencers list 500, one of the Influencer Names can be clicked on, which displays a detail page for that Influencer. It is emphasized that Influencers are hierarchically organized in relation to Hooms; that is, each Hoom may have one or more Influencers. Each Influencer is then ideally identified as an individual person (Contact). In the example shown in the Influencers list 500 of FIG. 5, it can be seen that there are four Influencers for the particular Hoom Sales @ ADP. More or fewer Influencers could be identified for each Hoom, depending on the size of the account and other factors.

FIG. 6 is an illustration of a portion of a Tohoom user interface page showing a list 600 of Collaborations for a particular Hoom, according to an embodiment of the present disclosure. Collaborate is the fourth and final phase of the sales prospecting methodology embodied in the Tohoom system. Collaborations are specific events or actions defined and performed in the Collaborate phase.

The Collaborations list 600 of FIG. 6 is accessed by clicking on the Collaborations heading at the top of the section 260 of the Hoom page 200 shown on FIG. 2. The Collaborations list 600 provides the ability for a sales rep or a first line sales manager to see a listing of Collaborations for any individual Hoom, along with the associated details. Some of the data in the Collaborations list 600 was shown in a different format in the section 260 of the Hoom page 200.

Collaborating is the fourth phase of the Tohoom methodology, and is entered when a Hoom is Connected with and has a Connected Status of “Established Relationship” (phase three is complete). Collaborations are special types of events which are intended to develop the relationship with the Hoom to the point where a sale can be made. Collaborations may be performed by people in the vendor organization other than the sales rep—such as a Sales Director, or a company vice president for example.

The first column of the Collaborations list 600 is Collaboration Name, and the last column is a Collaboration Type. Collaboration Type is a specific type of collaboration event chosen from a drop list. Examples of Types shown in FIG. 6 include Budget or Close, Peer Dinner and Strategy Sharing. Other Types could be included in the drop list for a particular vendor configuration of Tohoom. The Collaboration Name is the Collaboration Type concatenated with “for” and the Hoom ID. A Collaborating checkbox which follows the Collaboration Name is used to indicate which Collaborations are actively being worked on by either the sales rep or someone in the vendor organization.

The next column in the Collaborations list 600 is a Due Date, which is a target date set at implementation and edited by the system administrator each year. The Due Date is the date the sales leadership team wants a collaboration executed by. The next three columns in the Collaborations list 600 include a Completed checkbox, a Collaboration Date and Collaboration Notes. The Collaboration Date is automatically entered by the system when the Completed checkbox is checked; in other words, when an individual Collaboration occurs. Notes or follow-up comments may be added in the Collaboration Notes field.

When it is desired to make changes to any of the data shown on the Collaborations list 600, one of the Collaboration Names can be clicked on, which displays a detail page for that Collaboration. It is emphasized that Collaborations are hierarchically organized in relation to Hooms; that is, each Hoom may have one or more associated Collaboration events. In the example shown in the Collaborations list 600 of FIG. 6, it can be seen that there are three Collaborations for the particular Hoom. More or fewer Collaborations could be identified for each Hoom, depending on the size of the account and other factors.

The Tohoom system and methodology include a feature known as HUBs. A HUB is a Hoom Update Brief, which is a meeting or phone call held periodically between a first line sales manager and one or more of her sales reps. The purpose of the HUBs is to regularly review and update information in the Tohoom system, and plan upcoming milestones to achieve. The questions which may be asked and answered in each HUB include, for example;
Which Hooms did we plan on Finding, Connecting, Influencing & Collaborating with on the last HUB?
What outcomes were achieved?
Which Hooms will you be Finding, Connecting, Influencing & Collaborating with next period?

Tohoom provides features for efficiently reviewing previously agreed commitments for action items, updating status of each item, and “stamping” the outcome of a current meeting so that the commitments and outcomes can be reviewed at the next HUB meeting. These features are discussed below.

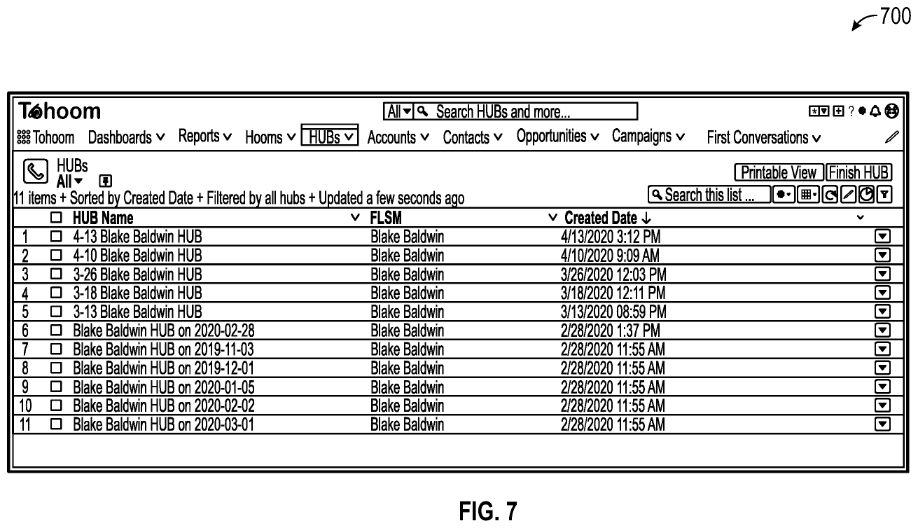

FIG. 7 is an illustration of a Tohoom user interface page for a list 700 of HUBs, or Hoom Update Briefs, according to an embodiment of the present disclosure. The HUBs list 700 is a list of previously-held HUBs for a particular Tohoom user—such as a first line sales manager. The HUBs list 700 includes a column for HUB name, which is simply the first line sales manager's name concatenated with the date the HUB call was held—where the manager's name and the date are the other two columns in the list. Filtering and sorting features are available as would be expected—including sorting by most recent date (as shown) and filtering by “All HUBs” for a particular manager (as shown) or filtering in some way.

The HUBs list 700 includes a Finish HUB button 710 which is used to complete a HUB call, where the actions and commitments decided in the HUB call are recorded (“stamped”) and the just-finished HUB will then appear in the HUBs list 700.

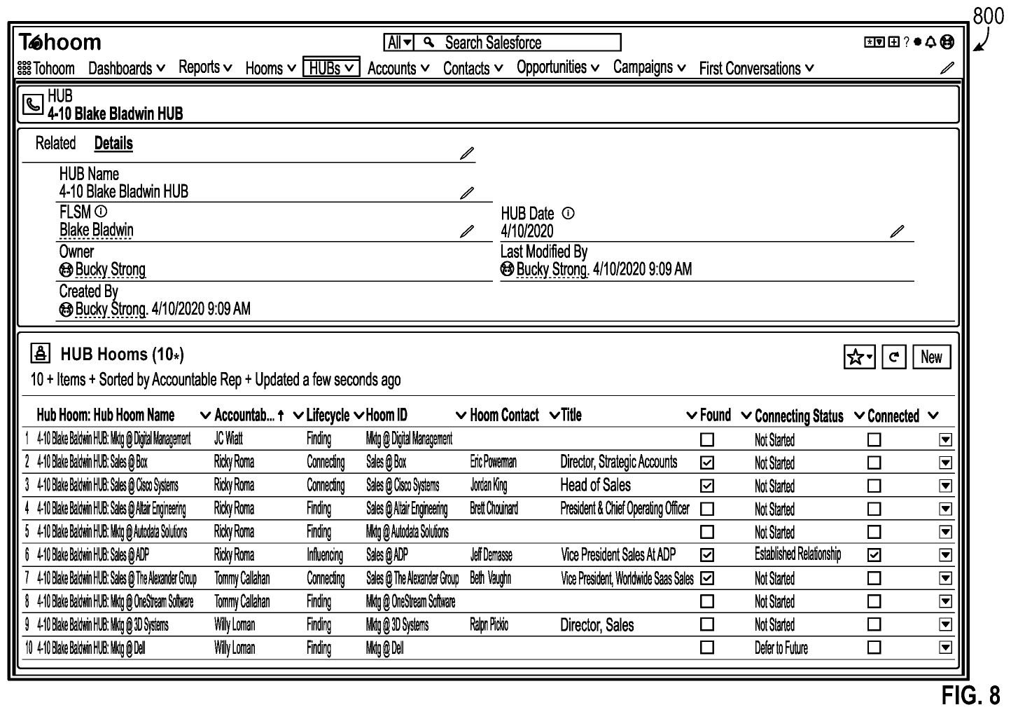

FIG. 8 is an illustration of a Tohoom user interface page for details page 800 of a specific HUB from the list of FIG. 7, according to an embodiment of the present disclosure. In a preferred mode of operation, a manager (e.g., first line sales manager) conducts a HUB “call” or meeting on a periodic basis—such as monthly. The term “HUB call” is used herein—but this should be understood to mean any type of discussion between the first line sales manager and one or more of the sales reps that report to her. The HUB call could be a physical meeting in a conference room (with interactive usage of the Tohoom system), or a virtual meeting with audio and video (showing the Tohoom system), or a combination thereof. The pronouns “him” and “her” are used arbitrarily here.

The HUB Details page 800 shows status information as recorded in a previous HUB. In particular, the HUB Details page 800 shows the details for the Apr. 10, 2020 Blake Baldwin HUB which was shown on the HUBs list 700. The HUBs Details page 800 is designed to allow the first line sales manager to efficiently review previous commitments and status with all of his sales reps in a single meeting.

On the HUBs Details page 800, the first column is HUB Hoom Name—which is an item associated with a particular Hoom from a particular previous HUB call. The second column is the accountable sales rep. On the HUBs Details page 800, four different sales reps (reporting to Blake Baldwin) are shown, and the HUB Hooms are sorted/grouped by sales rep. Other columns on the HUBs Details page 800 will be discussed below in connection with some examples.

The first item in the list on the HUBs Details page 800 shows that the Lifecycle status (third column) for the particular Hoom ID (fourth column) is Finding. This means that, in the Apr. 10, 2020 HUB call, the sales rep JC Wiatt indicated that she would find the Hoom Contact for that particular Hoom ID in the upcoming time period. Thus, on the HUB call presently being conducted (which might be a month after the April 10 call), the Hoom Contact should be identified. However, no Hoom contact name or title is entered, and thus this item has not been completed. This provides an opportunity for a discussion between the first line sales manager and the sales rep about why this has not happened, whether it will happen within the next meeting period, what obstacles might have prevented it, etc.

The second and third items in the list on the HUBs Details page 800 shows that the Lifecycle status is Connecting, but the Connecting Status is shown as Not Started, once again indicating that the intended action items have not been completed, and triggering a discussion about the items. The first line sales manager can switch to the Hoom detail screen if necessary to change status or details associated with a Hoom (for example, set the status back to Finding instead of Connecting if a Hoom Contact changed jobs). The Hoom detail screen for any Hoom can be immediately accessed by clicking on the Hoom ID which is a hotlink.

The fourth item in the list on the HUBs Details page 800 shows that the Lifecycle status is Finding, and the Hoom Contact name and title have been entered (before the meeting, by the sales rep), thus indicating that this action item has been completed as committed. The first line sales manager will then discuss the specific Hoom Contact to get the assurance of the sales rep that the person is in fact someone with budget and authority to make a purchase. If/when the first line sales manager is convinced that the Hoom Contact is valid, then the first line sales manager will click the Found checkbox for this Hoom ID. Recall that only the manager, not the sales rep, is permitted to click the Found checkbox. At this point, the sales manager would ask the sales rep if he wants to enter the Connecting phase now. If the answer is yes, then the sales manager would go to the Hoom details screen and click the Connecting checkbox and possibly enter a Connect By Date for that Hoom.

Each item in the list on the HUBs Details page 800 is reviewed in the manner discussed above during the current HUB call. It is important to note that the HUBs Details page 800 does not include an entry for every Hoom for every sales rep. The list on the HUBs Details page 800 only includes entries for Hooms which the sales rep has indicated presently in an active working phase (such as Finding or Connecting). This allows the first line sales manager and the sales rep to concentrate the discussion in the HUB call on those actions which were previously committed to.

After reviewing all of the actions that were scheduled for the last period (e.g., the prior month)—the actions/work of finding, connecting, influencing & collaborating are scheduled for next period in the same HUB call. This is done in the Hooms detail screen (see FIGS. 2 and 3). For example, the Finding box might be checked and the Find By Date entered for a certain Hoom ID, and the Found box and the Connecting box might be checked and the Connect By Date entered for another Hoom ID. Once all commitments have been checked and agreed upon, the FLSM goes back to the HUBs list (FIG. 7) & clicks the “Finish HUB” button 710; the Tohoom system captures all of these activities as a record of the HUB which was just finished (which would be shown as 5-10 Blake Baldwin, if the HUB call was held on May 10). This becomes the starting point for the next HUB call—the list of committed action items for next period (e.g., upcoming month).

Many different customized and configurable views of data may be created in the Tohoom system. For example, a director-level employee or officer of a vendor company may wish to see a list of all Hooms which have been identified for all sales accounts, with status information for each Hoom in the list. On the other hand, an individual sales rep will want to view and manage a list of all Hooms which he is responsible for, also with status information for each. Tools are provided in the Tohoom system for creation and configuration of such lists, and also for displaying corresponding data graphically in a Dashboard, as discussed below.

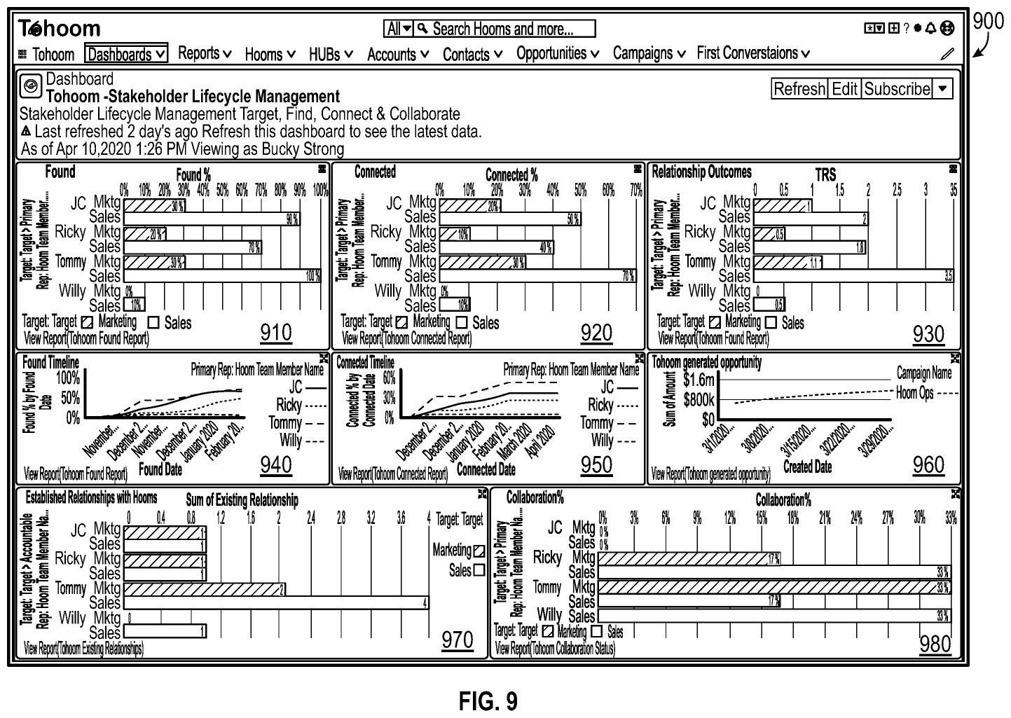

FIG. 9 is an illustration of a Tohoom user interface page for a Dashboard screen 900, or a collection of data graphs and charts for a particular user, according to an embodiment of the present disclosure. The Dashboard screen 900 includes a collection of graphs and charts which is configurable for each individual user of the Tohoom system.

As discussed earlier, any individual user in the Tohoom system is permitted to view and/or edit data fields based on user-account-specific roles. For example, a company president may be able to view all data for all sales reps and all accounts, but not be allowed to edit or change any of it. On the other hand, a sales rep will be able to view and edit all of his data, but may not be able to view data for other sales reps and accounts. Dashboard screens are set up and configured based on data available for viewing according to the permissions of the individual user.

The Dashboard screen 900 is an example based on a first line sales manager who has several sales reps reporting to her. The Dashboard screen 900 includes a number of “widgets”—which are individual graphs in a window pane which may be sized and placed as desired on the Dashboard screen 900.

Across a top row of the Dashboard screen 900 are a Found bar chart 910, a Connected bar chart 920 and a Relationship Outcomes bar chart 930. The Found bar chart 910 displays, for each of four different sales reps reporting to the first line sales manager, the percentage of Targeted Hooms for which the Hoom Contact has been Found. The data is further broken down into two bars for each sales rep—one for Hooms in their Marketing portfolio (target type), and one for Hooms in their Sales portfolio. The Connected bar chart 920 displays similar data for percentage of Hooms reaching the Connected status. The Relationship Outcomes bar chart 930 displays a measure of the Connecting Status field from the Connect phase, where each selectable option in the field has a corresponding numeric value (the Tohoom Relationship Score). Relationship Score values ranges from zero (Not Started or No Response) to four (Defer to Future) and five (Established Relationship). The Relationship Outcomes bar chart 930 displays the average Relationship Score for each sales rep, for the Marketing and Sales portfolios.

Across a middle row of the Dashboard screen 900 are a Found Timeline graph 940, a Connected Timeline graph 950 and an Opportunities graph 960. The Found Timeline graph 940 displays, for each of the four different sales reps reporting to the first line sales manager, a graph versus time showing the percentage of Targeted Hooms for which the Hoom Contact has been Found. The Connected Timeline graph 950 displays similar data for percentage of Hooms reaching the Connected status. The Opportunities graph 960 displays a graph versus time of the monetary value of sales Opportunities generated from the Tohoom system and loaded into the CRM system, for the first line sales manager who owns this particular Dashboard screen 900.

Along the bottom row of the Dashboard screen 900 are an Established Relationships bar chart 970 and a Collaborations bar chart 980. The Established Relationships bar chart 970 depicts, for each of the four different sales reps reporting to the first line sales manager, the number of Targeted Hooms for which the sales rep has an Established Relationship with the Hoom Contact—as determined by the Connecting Status field discussed earlier. The data is further broken down into two bars for each sales rep—one for Hooms in their Marketing portfolio, and one for Hooms in their Sales portfolio. The Collaborations bar chart 980 displays, for Hooms that have reached Collaboration status, the percentage of Collaborations which are due (past their due date) that were actually completed.

Other types of graphs and charts may also be included in the Dashboard screen 900, including bar charts, graphs, etc., displaying performance for any data field available in the Tohoom system, as can be envisioned by someone skilled in the art.

FIG. 10 is an illustration of a Tohoom user interface page for details of a Hoom and showing a First Conversations summary screen 1000, according to an embodiment of the present disclosure. First Conversations is a feature of Tohoom which guides the conversations to be held between a sales rep and a Hoom. These are suggested talking points a rep may have when first connecting in conversation with a Hoom. The content shown in screen 1100 (below) is created by an industry expert at the vendor, usually a marketing person or industry advisor. The First Conversations summary screen 1000 may be accessed by clicking on the First Conversations menu tab, or by clicking on the Target name when on a Hoom screen such as shown in FIG. 2.

The First Conversations summary screen 1000 shows the First Conversations which are associated with a particular Target based on the industry selected in the screen 1100. The particular Target shown on the First Conversations summary screen 1000 has only one First Conversations listed. In addition to the First Conversations Name in the first column, which is named as a combination of the Target & Industry for that Hoom, a short version of a Situation and a Conversation are listed in the second and third columns, and a subject matter expert is identified in the fourth column. The subject matter expert is the person at the vendor who created the content as described above.

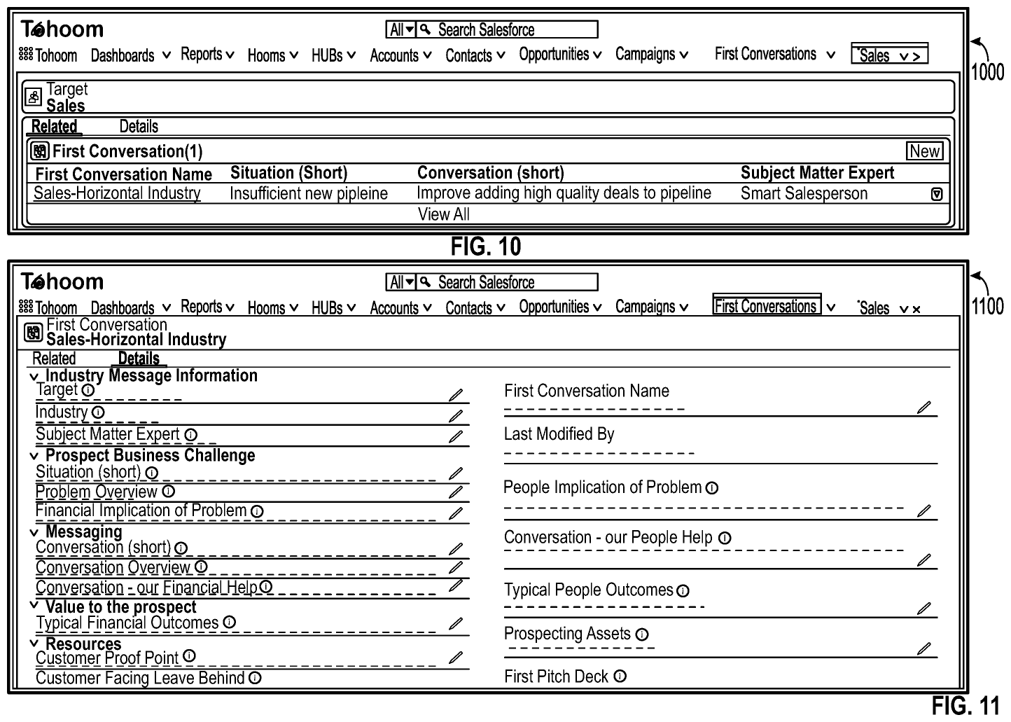

FIG. 11 is an illustration of a Tohoom user interface page for a First Conversations details screen 1100, according to an embodiment of the present disclosure. The First Conversations details screen 1100 is accessed by clicking on the First Conversations Name on the First Conversations summary screen 1000. The information on the First Conversations details screen 1100 supports the conversation the sales rep will have with the targeted prospect/Hoom. It is organized by target by industry; this information guides the sales rep through the Hoom's problem, how the problem is alleviated & the financial benefit of alleviating the problem.

The First Conversations details screen 1100 includes all of the content that the vendor experts have supplied for the rep and supports a first conversation held between the sales rep and the target. This information is arranged into groupings including industry information, the prospect's business challenge that the vendor hopes to solve, conversation description, value to the prospect that the vendor solution can offer, vendor resources that may be needed in order to deliver the solution, etc. In addition, data fields are provided for items such as the name of the First Conversations, modified date, and other vendor resource references.

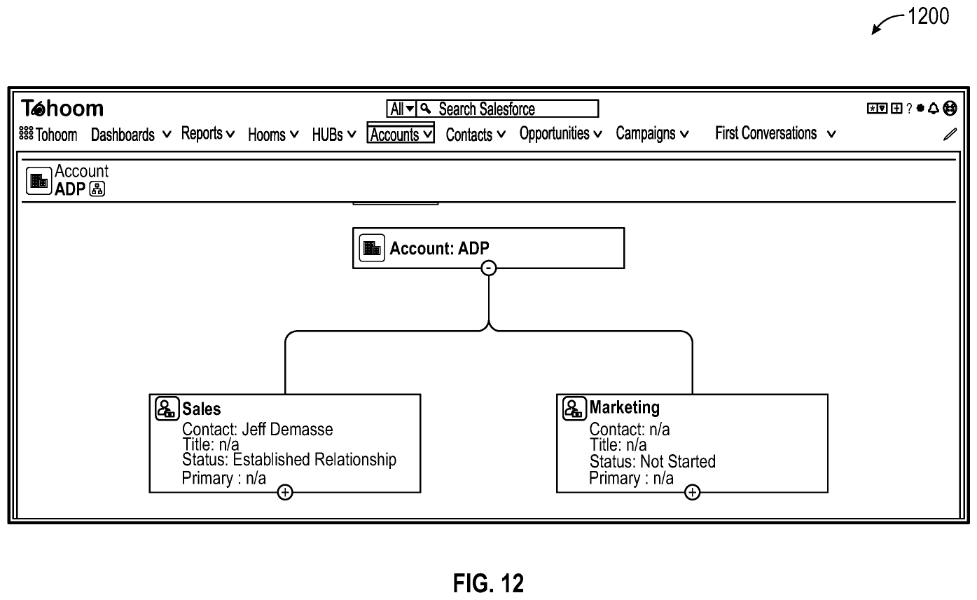

FIG. 12 is an illustration of a Tohoom user interface page for an Influencer Map screen 1200, according to an embodiment of the present disclosure. Influencer Maps is another feature of Tohoom which can enable the vendor sales organization to more effectively prospect for sales. The Influencer Map screen 1200 is accessed either from the Account detail screen which shows “All” Hoom Influencer Map or from the Hoom detail screen which shows just the “one” Influencer Map for that Hoom.

The Influencer Map is a live visual organizational map of the Account—Hoom—Influencer. It always shows current data from Tohoom and is never outdated. The Influencer Map is color coded for each Hoom or Influencer based on its current phase within the Tohoom Stakeholder Lifecycle. This visual helps the user see the relationship whitespace in their accounts & their lifecycle status, at a glance. It is the big picture represented in a way that is easy to digest.

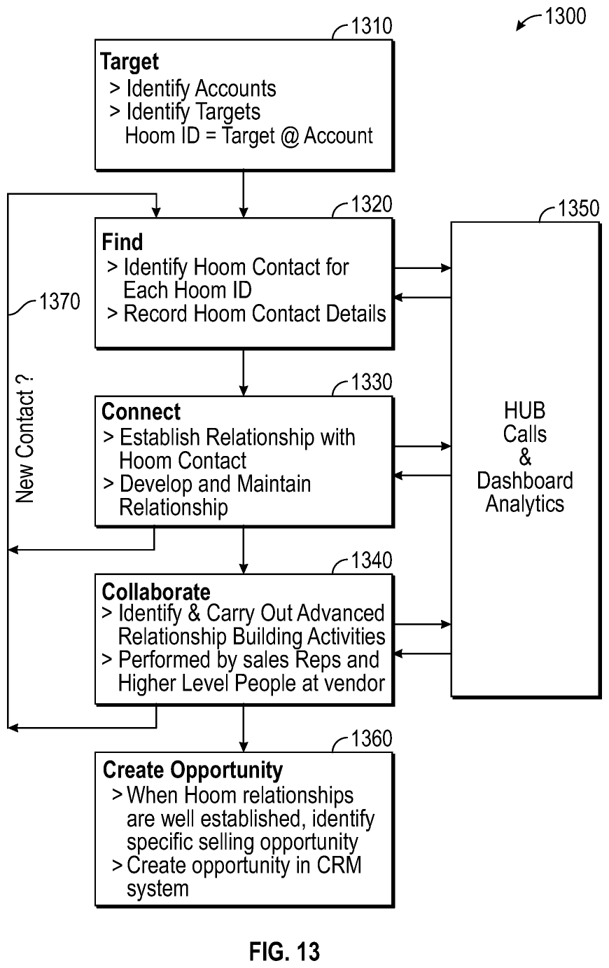

FIG. 13 is a flowchart diagram 1300 of a method for sales prospecting stakeholder lifecycle management using the Tohoom system, according to an embodiment of the present disclosure. At box 1310, the Target phase of the method is performed. The Target phase includes identifying accounts to which future sales could potentially be made, and identifying Targets (economic buyers) at the accounts. The Hoom ID is then the Target @ Account.

At box 1320, the Find phase of the method is performed. The Find phase includes identifying a Hoom Contact (an actual person) for each Hoom ID. The Hoom Contact is the person filling the Target role (such as Purchasing Director) at the Account. Details of the Hoom Contact (job title, address and contact information) are recorded if available. In a preferred embodiment, the Hoom Contact's details are retrieved from the CRM system, and/or retrieved from a business networking system.

At box 1330, the Connect phase of the method is performed. The Connect phase includes establishing a relationship with a Hoom Contact. Relationship Status can range from Not Started, to a dead end (Not Interested), to In Progress or Accepted Next Step. The Ultimate Relationship Status goal is Established Relationship, which completes the Connect phase. The relationship must be maintained over time; if the Tohoom system does not detect certain activity in connection with a Hoom, the Relationship Status will eventually be set to Stale.

At box 1340, the Collaborate phase of the method is performed. The Collaborate phase includes identifying and carrying out advanced relationship building activities with the Hoom. These advanced relationship building activities include things like holding a strategy sharing session between the vendor and the account, or taking the Hoom and/or other Influencers at the account to dinner or an event (golf tournament, auto race, etc.). Although the sales rep may be involved in the scheduling of the collaborative event, and may even take part in it, the collaborative events often involve higher level people from the vendor—such as a Sales Director, a VP, etc.

Box 1350 includes holding HUB calls and using Dashboard analytics features of the Tohoom system. These were discussed in detail previously. The HUB calls and Dashboard features are used continuously and repeatedly throughout the Find, Connect and Collaborate phases of the method, as shown by the two-way arrows. During the HUB calls, action plans are made and progress is recorded in the Tohoom system for each of the Find, Connect and Collaborate phases of the method.

At Box 1360, sales opportunities are identified. Creating sales opportunities happens when Hoom relationships are well established, typically following some Collaboration events. For example, through collaboration with a Hoom, it may be determined that the Hoom account has a need for a certain product or service that is offered by the vendor—either as a new product or service to the account, or as a replacement for a similar product or service from another vendor. Sales opportunities are created and tracked in the CRM system with which the Tohoom system has a two-way interface.

On Line 1370, when an identified Hoom contact leaves his or her role at the account (moves to a different company; changes jobs within the account; etc.), the process loops back to the Find box 1320 to once again identify the correct Hoom contact for the Hoom ID. This loop back to the Find box 1320 could happen at any time during the Connect phase or the Collaborate phase of the method.

Other steps may implicitly be included in the method, including features described previously. These features include reviewing and updating data using other Tohoom detail screens, defining and working with Influencers, and establishing a Hoom team at the vendor. These features further include the two-way interface to a CRM system. Sales reps and others of course perform other steps not explicitly shown on the flowchart diagram 1300—such as meeting and corresponding with Hooms and Influencers, meeting internally with their Hoom team, researching account activity, etc.

As will be well understood by those skilled in the art, the several and various steps and processes discussed herein to describe the disclosed methods may be referring to operations performed by a computer, a processor or other electronic calculating device that manipulate and/or transform data using electrical phenomenon. In particular, this refers to the server 100, the computer 132 and the mobile device 142 shown in FIG. 1 and discussed above. Those processors and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media. Further, the server 100, the computer 132 and the mobile device 142 described above are understood to be in communication with each other via any suitable wired or wireless communication channel for the sharing of application screens, input data, output data, etc.

Using the methods and system disclosed above, sales prospecting can be organized into a structured stakeholder lifecycle management methodology, where sales prospecting efforts have previously been relegated to spreadsheets and ad hoc processes. The disclosed methods and system have been demonstrated to improve the orderliness and efficiency of the sales prospecting process, and to result in increased sales, for vendor sales organizations which have implemented them.

The foregoing discussion describes merely exemplary embodiments of the present disclosure. One skilled in the art will readily recognize from such discussion and from the accompanying drawings and claims that various changes, modifications and variations can be made therein without departing from the spirit and scope of the invention as defined in the following claims.

What is claimed is:

1. A system for sales prospecting by a vendor company, said system comprising:
a computer including a processor, a memory module and a network connection, where the computer is configured with an application program and database for sales prospecting using a stakeholder lifecycle management methodology including;
a target phase where a Hoom, or economic buyer with budget and authority, is identified for a potential sales account, and a Hoom ID is entered in the system;
a find phase where a Hoom Contact, or named person, is identified for the Hoom ID and entered in the system;
a connect phase where a relationship is established with the Hoom Contact, and a Connecting Status is entered in the system; and
a collaborate phase where strategic interactions with the Hoom Contact are scheduled and completed;
and where the system further includes a Hoom Update Brief (HUB) page which displays, for each Hoom ID for each sales representative reporting to a manager, milestones which were scheduled to be achieved in each of the phases during a current time period.

2. The system of claim 1 wherein the computer is a server computer providing application pages and data to client computers running web browser software.

3. The system of claim 1 wherein the target phase includes identifying the sales account and assigning the sales account to one of the sales representatives, and identifying a target persona, or organizational role at the account, where the Hoom ID is the target persona at the account.

4. The system of claim 1 wherein the find phase includes a checkbox to indicate the find phase has begun, a Find By commitment data, the name and job title of the Hoom Contact when found, a checkbox to indicate the find phase is complete, and a Found Date.

5. The system of claim 1 wherein the connect phase includes a checkbox to indicate the connect phase has begun, a Connect By commitment data, a Connecting Status with a corresponding Relationship Score, a checkbox to indicate the connect phase is complete, and a Connected Date.

6. The system of claim 5 wherein the Connecting Status is selected from a list including; Not started, In progress, Accepted next step, Defer to future, Using competitor, Not interested, No response, Stale relationship, and Established relationship.

7. The system of claim 6 wherein Stale relationship is automatically determined by the system when no collaboration events are completed for a Hoom Contact within a predefined period of time, and where Established relationship is the Connecting Status having a highest Relationship Score.

8. The system of claim 5 wherein the connect phase further includes identifying one or more influencers at the sales account, where the influencers are people besides the Hoom Contact who will have an influence on a purchase decision.

9. The system of claim 5 wherein the connect phase further includes identifying one or more members of a Hoom team, where the members of the Hoom team are people at the vendor company who can assist the sales representative in developing the relationship with the Hoom Contact.

10. The system of claim 1 further comprising a Finish HUB button which records status changes and action items defined during a HUB call, including changes made from a review of the HUB page, and changes made to other data from the target, find, connect and collaborate phases.

11. The system of claim 1 further comprising a dashboard page where graphs of system data are displayed, including configurable selection, sizing and placement of the graphs.

12. The system of claim 1 wherein the system includes a two-way data interface to a Customer Relationship Management (CRM) system.

13. A sales prospecting system for use by a vendor company, said system comprising:
a computer including a processor, a memory module and a network connection, where the computer is configured with an application program and database for sales prospecting using a stakeholder lifecycle management methodology including;
a Hoom page where a Hoom, or economic buyer with budget and authority at a sales account, is tracked through a target phase where a Hoom ID is entered in the system, a find phase where a Hoom Contact, or named person, is identified for the Hoom ID and entered in the system, a connect phase where a relationship is established with the Hoom Contact, and a Connecting Status is entered in the system, and a collaborate phase where strategic interactions with the Hoom Contact are scheduled and completed;
a Hoom Update Brief (HUB) page which displays, for each Hoom ID for each sales representative reporting to a manager, milestones which were scheduled to be achieved in each of the phases during a current time period;
a dashboard page where graphs of system data are displayed, including configurable selection, sizing and placement of the graphs; and
a two-way data interface to a Customer Relationship Management (CRM) system, where sales account and contact data are imported from the CRM system into the sales prospecting system, and selling opportunities are exported from the sales prospecting system into the CRM system.

14. A method for sales prospecting by a vendor company, said method being carried out using a computer system running on a computer with memory, said method comprising:
completing a target phase where a Hoom, or economic buyer with budget and authority, is identified for a potential sales account, and a Hoom ID is entered in the system;
completing a find phase where a Hoom Contact, or named person, is identified for the Hoom ID and entered in the system;
completing a connect phase where a relationship is established with the Hoom Contact, and a Connecting Status is entered in the system;
completing a collaborate phase where strategic interactions with the Hoom Contact are scheduled in the system and completed; and
conducting Hoom Update Briefs (HUBs) where managers review with their sales representatives milestones, displayed by the system, which were scheduled to be achieved in each of the phases during a current time period.

15. The method of claim 14 wherein the target phase includes identifying the sales account and assigning the sales account to one of the sales representatives, and identifying a target persona, or organizational role at the account, where the Hoom ID is the target persona at the account.

16. The method of claim 14 wherein the find phase includes checking a checkbox in the system to indicate the find phase has begun, entering a Find By commitment data, entering the name and job title of the Hoom Contact when found, checking a checkbox to indicate the find phase is complete, and entering a Found Date.

17. The method of claim 14 wherein the connect phase includes a checking checkbox in the system to indicate the connect phase has begun, entering a Connect By commitment data, entering a Connecting Status with a corresponding Relationship Score, checking a checkbox to indicate the connect phase is complete, and entering a Connected Date.

18. The method of claim 17 wherein the Connecting Status is selected from a list including; Not started, In progress, Accepted next step, Defer to future, Using competitor, Not interested, No response, Stale relationship, and Established relationship.

19. The method of claim 17 wherein the connect phase further includes identifying one or more influencers at the sales account, where the influencers are people besides the Hoom Contact who will have an influence on a purchase decision.

20. The method of claim 17 wherein the connect phase further includes identifying one or more members of a Hoom team, where the members of the Hoom team are people at the vendor company who can assist the sales representative in developing the relationship with the Hoom Contact.
